(19) United States
(12) Patent Application Publication
(10) Pub. No.: US 2004/0119860 A1
(43) Pub. Date: Jun. 24, 2004

(54) Method of colorimetrically calibrating an image capturing device

(75) Inventors: Richard M. Vogel, Pittsford, NY (US); Erin S. Wanek, Webster, NY (US); James M. Enge, Spencerport, NY (US); Bruce H. Pillman, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/328,612

(22) Filed: Dec. 23, 2002

(51) Int. Cl. H04N 5/335

(52) U.S. Cl. 348/272

(57) ABSTRACT

A method of calculating a set of color-correction matrix coefficients for an image capturing device uses an LED illuminator having programmable output characteristics and spectral characteristics. A first XYZ data set is created from computed tristimulus values for each of the object stimulus. An image of each one of the predetermined set of object stimulus is captured thereby producing a plurality of images. RGB values are determined and normalized for each image thereby creating an RGB data set. A set of color-correction matrix coefficients are then calculated for the RGB data set corresponding to the first XYZ data set, thereby producing a color corrected RGB data set.

### FIELD OF THE INVENTION

This invention pertains to the field of digital imaging and, more particularly, to the optimization of the color performance of digital imaging devices, such as digital cameras and scanners.

### BACKGROUND OF THE INVENTION

Correction matrices are useful in a variety of color imaging applications to effect color conversion or correction. For instance, a conversion matrix is used to convert red, green, and blue video signals into Y (luminance) and I, Q (chrominance) signals. A color-correction matrix is used to correct the spectral sensitivities of a video camera for the chromaticities of the primaries and white point of the particular display in use. This display may, for example, take the form of a cathode-ray tube (CRT), a liquid-crystal display (LCD) or an organic light-emitting diode (OLED) display. Another use is with film-to-video conversion, a process in which a color-correction matrix operates on the film scanning signals to correct the film colorimetry for video display. While these systems were typically analog systems, matrix processing is particularly adapted to a digital environment.

Continuing advances in semiconductor technology in areas such as digital memory, digital application-specific integrated circuits (ASICs), and charge-coupled device (CCD) imagers have made possible the introduction in recent years of digital electronic cameras. Evolution of this product segment will be driven by ever increasing consumer demands for better performance in such areas as resolution, photographic speed, and color reproduction. In the area of color reproduction it is desirable to select an optimum set of spectral characteristics for the CCD imager. The prior art (for example, as described in Color Science in Television and Display Systems by W. N. Sproson, published by Adam Hilger Ltd., 1983), teaches that one step toward the goal of good color reproduction is to choose a set of spectral characteristics for the camera which are as close as possible to the spectral characteristics of the intended display device. In the aforementioned Sproson text, a CRT is used as an example of a typical display device where the defining spectral characteristics are easily derived by one skilled in the art from knowledge of the CRT's phosphor chromaticities and white-point setting, as well as from knowledge of the spectral response of the human eye. The resulting spectral curves are referred to as the color-matching functions (CMFs) for the display.

It is desirable to have the camera exhibit spectral sensitivities only in the visible portion of electromagnetic spectrum (approximately 400 to 700 nm.). In addition, it is desirable that the overall spectral sensitivities of the camera correspond to a set of all-positive color-matching-functions (CMFs). If these requirements are met, the camera will be able to discern color information in the scene in much the same way that a human observer does. Failure to achieve this goal will result in color reproduction errors. (This failure mechanism is referred to as metamerism.)

A set of spectral curves is defined as a set of CMFs if, and only if, it can be exactly derived from the spectral response of the human eye via a linear 3×3 transformation. An infinite number of CMFs are possible according to this definition. The CIE (Commission Internationale De L'Eclairage) has published standardized spectral data sets describing the response of the human eye. This data may be found in CIE publication 15.2 (1986) Colorimetry—Second Edition in table 2.5. Another useful feature of CMFs is the fact that any two sets of CMFs are directly related to each other through a unique 3×linear transformation.

One practical limitation in the selection of a set of CMFs for the camera is the restriction that they be all positive, whereas the CMFs describing a color CRT typically have negative lobes. This is not a problem in practice since a linear 3×3 transformation may be employed, as discussed above, to correct the camera's output color signals for rendition on the CRT display. This linear 3×3 transformation is often referred to in the art as a color-correction matrix. Another practical restriction in the selection of a set of camera CMF's is the need to minimize the size of the off-diagonal coefficients in the color-correction matrix since these are directly responsible for degrading the noise performance of the imaging system.

As described in U.S. Pat. No. 5,668,596, issued Sep. 16, 1997 to Richard M. Vogel, and titled “Digital Imaging Device Optimized For Color Performance,” hereby incorporated herein by reference, the optical path of an electronic camera may consist of various components—each with its own spectral characteristics. Among these components one would ordinarily find a lens, blur-filter, infra-red cut-off filter and a CCD or CMOS imager with an integral color-filter array (CFA). However, some applications with multiple imagers use a set of color separation filters instead of an integral CFA. The overall spectral sensitivity of the camera is determined by the combined spectral responses of the individual components. FIG. 1 illustrates the spectral characteristics for a typical color CCD camera including the combined effects of all of the optical components. These curves have been normalized to unit response for comparison purposes as is the standard practice when working with color-matching functions.

Included in FIG. 1 is a second set (dotted lines) of curves representing the transformed spectral characteristics of the camera following the color-correction matrix operation. Note that the transformed spectral responses have negative lobes whereas the original camera spectral responses do not. FIG. 2 compares the transformed spectral responses of the camera (dotted lines) with the CMFs for a CRT having CCIR Rec. 709 phosphors and a 6500 Kelvin white point. It can be seen that elements in a real camera have errors in spectral response that prevent replication of CMFs regardless of the transformation. Errors are normally spread among all colors in a way that minimizes color errors, but the result inevitably is not a perfect match, as seen particularly in the transformed camera red spectral response in FIG. 2.

The use of a color-correction matrix is shown in U.S. Pat. No. 5,253,047, issued Oct. 12, 1993 to Eiji Machishima, and titled “Color CCD Imager Having A System For Preventing Reproducibility Degradation Of Chromatic Colors,” in which a color temperature detecting circuit modifies the matrix coefficients for a primary color separator used to perform a color-correction operation for a color video camera. The primary color separator is used to compute the red, green, and blue primary color signals for the luminance/chrominance signals generated by the camera detector circuitry. In U.S. Pat. No. 5,805,213, issued Sep. 8, 1998 to Kevin E. Spaulding, et al., and titled “Method and Apparatus for Color-Correcting Multi-Channel Signals Of A Digital Camera,” an improved method is used to select the color-correction matrix coefficients to account for changes in illuminant color temperature. In particular, this method provides optimum compensation for variations in the scene illuminant by using all of the degrees-of-freedom available in the primary color separator matrix.

A color-correction matrix is shown in U.S. Pat. No. 5,001,663 issued Apr. 30, 1991 to Alberto Innocenti, and titled “Multitest-Tube For Clinical Chemistry Analysis For Several Simultaneous Tests,” as one component of a digital-signal processing chipset for a high performance digital color video camera. The implementation illustrated requires that the matrix be mask-programmed into the chip during fabrication. This approach fixes the matrix coefficients during the production process such that color-correction is specific to a defined type, or family, of cameras. This is ordinarily done by establishing the matrix coefficients to account for the optical component spectral characteristic or illuminant color temperature of a defined reference camera, and then embodying these coefficients in each manufactured camera.

U.S. Pat. No. 5,189,511 issued Feb. 23, 1993 to Kenneth A. Parulski, et al., and titled “Method And Apparatus For Improving The Color Rendition Of Hardcopy Images From Electronic Cameras,” is a further example of this approach, describing improved resolution and reproduction of hard copies made from images captured by different types of electronic still cameras. Subtractive-type color processing is used to attempt to stabilize the primaries associated with image dyes used to produce the hard copy images, preceded by additive-type processing which attempts to correct the camera sensitivities appropriately for the stabilized primaries. The additive-type color processing may be in the camera itself to ensure that each output device achieves optimum color reproduction from signals corresponding to those provided by a defined reference camera. This arrangement allows signals from different types of cameras, i.e., corresponding to different defined reference cameras (e.g., high resolution professional cameras vs. low resolution consumer cameras), to provide input to different types of hardcopy devices and media.

As digital cameras and low cost scanners proliferate in the marketplace, there is increased need that images from comparable cameras or scanners produce comparable colors to the human observer. Unfortunately, small variations in optical component spectral characteristics, even within the same family of cameras, can produce noticeable color differences in the output images. Heretofore, the approaches taken do not account for variations in optical component spectral characteristics from individual imaging device to individual imaging device.

Therefore, a need persists in the art for a method of calorimetrically calibrating an image capturing device that is simple to use, cost effective to implement and produces optimal color uniformity in the same digital images from different image capture devices.

### SUMMARY OF THE INVENTION

The aforementioned problems are solved with a technique for optimum color-correction utilizing customized matrix coefficients for a particular imaging device. According to the invention, a method of calculating a set of color-correction matrix coefficients for an image capturing device uses an LED illuminator having programmable output characteristics and spectral characteristics. A first XYZ data set is created from computed tristimulus values for each of the object stimulus. An image of each one of the predetermined set of object stimulus is captured thereby producing a plurality of images. RGB values are determined and normalized for each image thereby creating an RGB data set. A set of color-correction matrix coefficients are then calculated for the RGB data set corresponding to the first XYZ data set, thereby producing a color corrected RGB data set.

The present invention has several advantages over prior art developments. Besides providing an optimal level of color-correction, the present invention has the advantage that the color reproduction variation from one camera to the next is accordingly minimized. This reduces the occurrence of color nonuniformity between the same digital images captured by different digital cameras. Additionally, the need for a physical color chart and associated accurate illumination source are eliminated.

### BRIEF DESCRIPTION OF THE DRAWINGS

FIG. 1 is a comparison of the normalized original camera spectral characteristics and the transformed spectral characteristics following application of a color-correction matrix,

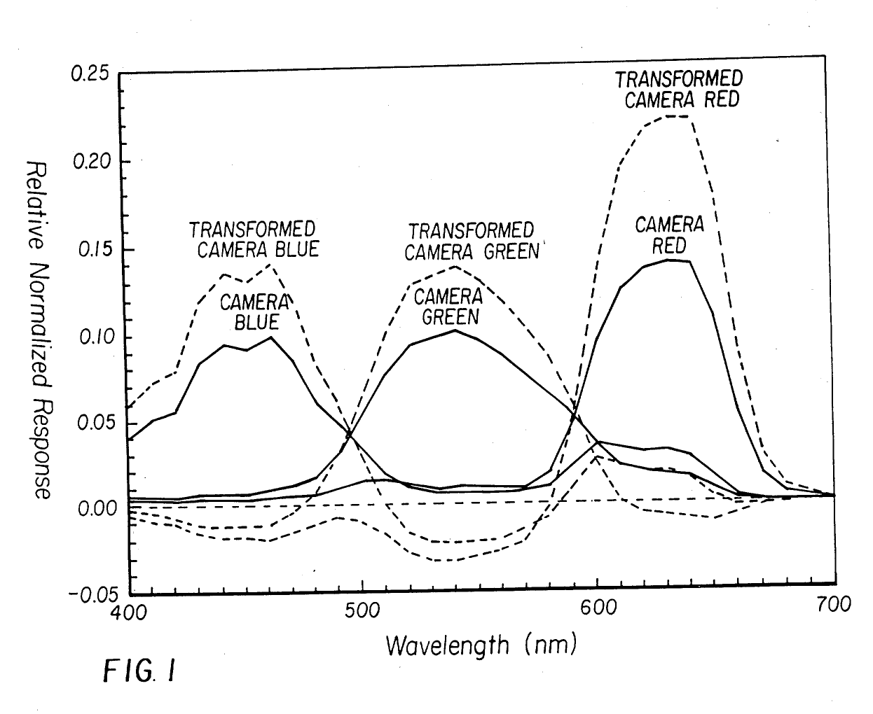

FIG. 2 is a comparison of the transformed camera spectral characteristics from FIG. 1 and the actual CMFs for a particular CRT,

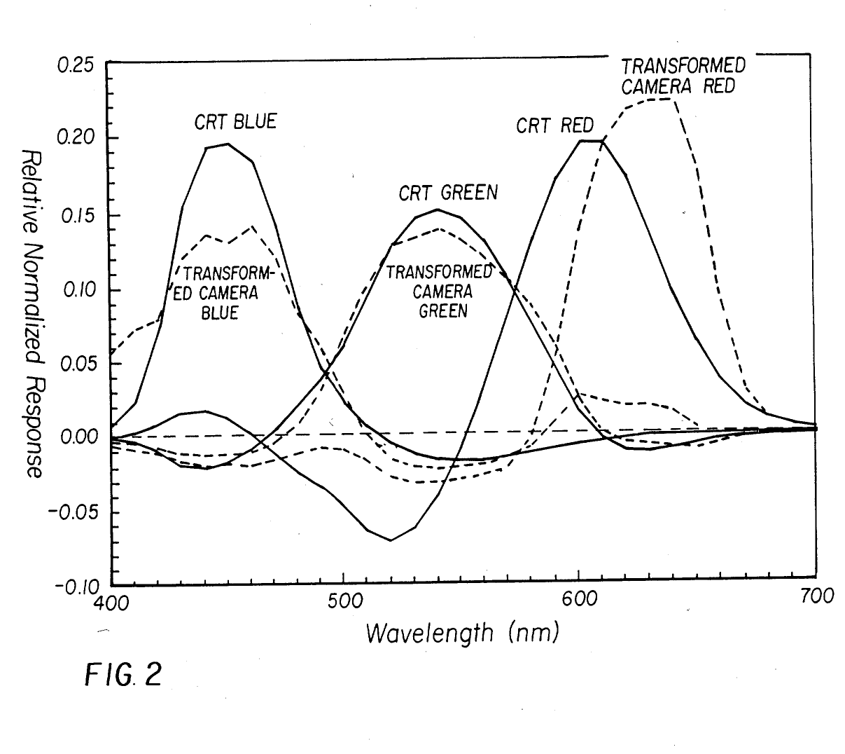

FIG. 3 is a block diagram showing the color matrix located on the optical assembly of the camera, but the actual color-correction operation utilizing the matrix is performed external to the camera,

FIG. 4 is a block diagram showing the color matrix located on the optical assembly of the camera and the color-correction operation is performed internal to the camera;

FIG. 5 is a block diagram showing the color matrix is located within the camera but external to the optical assembly of the camera;

FIG. 6 is a block diagram of an electronic imaging system incorporating an imaging device in accordance with the invention; and

FIG. 7 is a block diagram outlining a general method of the invention for obtaining the color-correction matrix coefficients using an LED illuminator;

### DETAILED DESCRIPTION OF THE INVENTION

Because electronic imaging devices employing electronic sensors are well known, the present description will be directed in particular to elements forming part of, or cooperating more directly with, apparatus in accordance with the present invention. Elements not specifically shown or described herein may be selected from those known in the art. Certain aspects of the embodiments to be described may be provided in software. Given the system description as described in the following materials, all such software implementation is conventional and within the ordinary skill in such arts.

As understood in the prior art, a digital imaging device is a device which uses an electronic sensor to capture an image either directly from an object or indirectly from a medium, such as film; signal processing to represent the captured signal numerically; and some storage device to preserve the numerical image data. It is further known for a digital imaging device, particularly a digital camera, to use a removable storage device, such as an integrated circuit memory card, to store images. For instance, U.S. Pat. No. 5,016,107, issued May 14, 1991 to Steven J. Sasson, et al., and titled “Electronic Still Camera Utilizing Image Compression And Digital Storage,” describes an electronic still camera utilizing image compression and providing digital storage in a removable memory card having a static random access memory. In this camera, the integrated circuits in the removable memory card store image data and a directory locating the data. The image data provided by the digital imaging device and stored in a memory card is ordinarily used to produce some type of display or print, for example, a CRT display or a digital print made from images scanned from film or taken by an electronic camera.

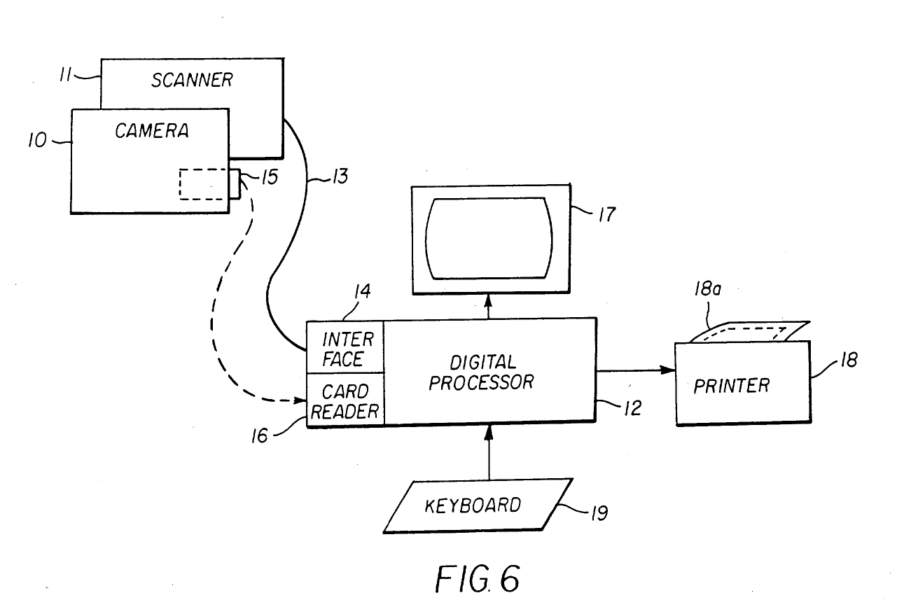

As shown in FIG. 6, the digital imaging device, which may be an electronic camera 10 or a scanner 11, is utilized in a system including a digital processor 12. The digital image information produced by the digital imaging device is downloaded to the peripheral digital processor 12, as shown in FIG. 6, for further processing into a digital image. The downloading can be accomplished for either device in a number of ways, for instance by a cable connection 13 through an interface 14, or by removable media, such as a memory card 15, through a card reader 16. A suitable color CRT display 17 is connected to the digital processor 12 for displaying the images, and a printer 18 is connected to print out copies 18a of the images. A keyboard 19 is also connected for use in the processing of the images. The digital processor 12, which can be part of a conventional programmed computer, utilizes conventional processing techniques to process the digital image information according to algorithms stored in the computer or provided by application software used with the computer. For example, the digital processor 12 may include a conventional color management system, which links the input device (camera 10 or scanner 11) and the output device (CRT 17 or printer 18) by utilizing device profiles appropriate for the type of input and output devices used (e.g., one input profile for the camera 10 and another input profile for the scanner 11).

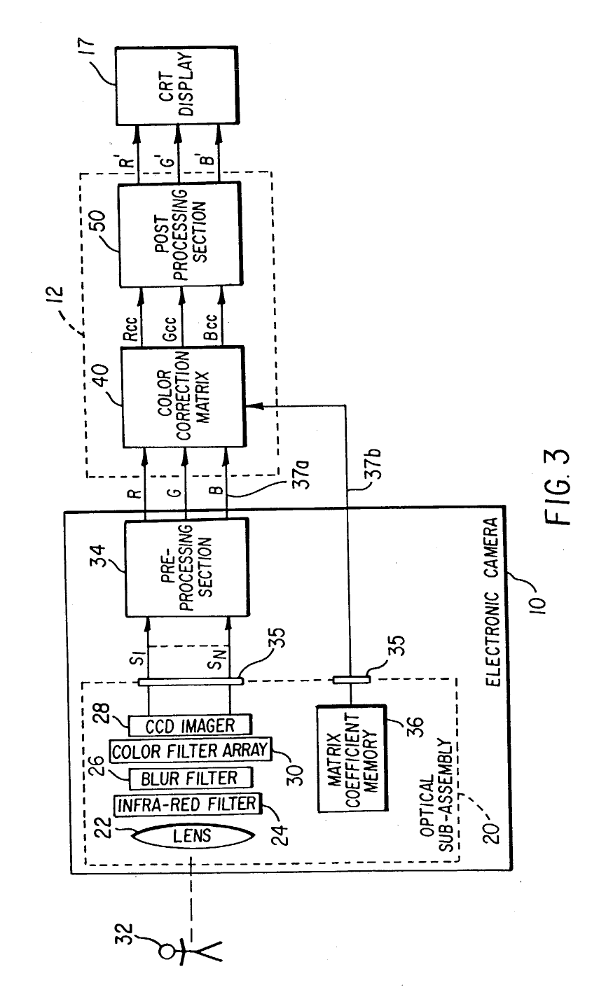

The ultimate color performance of an electronic camera is directly influenced by the various optical components that comprise the image capture path. It is possible to maximize the color reproduction accuracy of a particular camera by computing a unique color-correction matrix for that camera which compensates for the unique optical characteristic of that camera. This approach also minimizes the variation in color reproduction from one camera to the next. With reference to FIG. 3, a simplified block diagram illustrating the preferred embodiment of the invention is shown. The electronic camera 10 has an optical sub-assembly 20 containing a lens 22, an infrared cutoff filter 24, a blur filter 26 and a CCD imager 28 with an integral color filter array (CFA) 30. The optical sub-assembly 20 has predetermined spectral characteristics, comprising the combination of the spectral sensitivities of the CCD imager 28 and the spectral characteristics of the lens 22, the infrared cutoff filter 24, and the blur filter 26. Due to these spectral sensitivities and spectral characteristics, the combination thereof uniquely distinguish this imaging device from other imaging devices of the same type. In other words, although different cameras contain nominally identical optical elements, including sensors, their overall spectral responses will differ from camera to camera.

Referring to FIG. 3, the optical sub-assembly 20, which is used to capture an image of a scene 32, is designed to be removable from the camera 10 for purposes of servicing and calibration. When installed in the camera 10, the optical sub-assembly 20 electrically connects to a preprocessing section 34 through an electrical connecting means 35. Image-wise signals S₁-S_{N} from the CCD imager 28 are converted to digital, linear RGB format within the camera by the pre-processing section 34 using techniques and components familiar to those skilled in the art. These digital RGB signals represent the red, green, and blue primary components of the image, respectively. Pre-processing section 34 may perform such well-known tasks as double-correlated sampling of the CCD signals, black-level control, white-balance, analog-to-digital conversion, conversion of the CCD signals to RGB, and interpolation of the CFA data to produce RGB values at each pixel location.

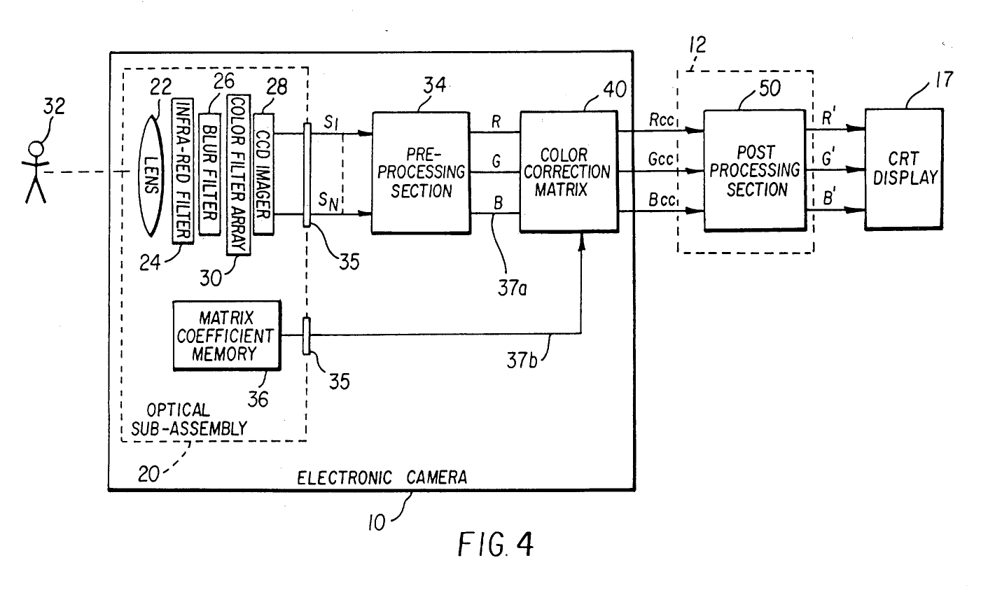

Digital RGB values from the pre-processing section 34 are transformed to a set of color-corrected RGB values (R_{CC}, G_{CC}, B_{CC}) suitable for display on the color CRT display 17 by processing in a color-correction matrix operation 40. In this embodiment of the invention, the color-correction matrix 40 operation is performed external to the camera 10 as is shown in FIG. 3 in, for example, the digital processor 12 shown in FIG. 6. Therefore, the RGB signals and the matrix coefficients are provided to the external digital processor 12 via interface lines 37a, 37b. In a second version of the preferred embodiment of this invention, the color-correction matrix 40 operation is performed internal to the camera as illustrated in FIG. 4. Where this step is performed is not important to the teaching of this invention. In either case the color-correction matrix 40 operation is performed on RGB signals which vary linearly with exposure.

Color-corrected RGB signals (R_{CC}, G_{CC}, B_{CC}) following the color-correction matrix 40 operation are converted to a format suitable for CRT display by a post-processing section 50 using techniques and components familiar to those skilled in the art. Such post processing operations may include such tasks as interpolation, edge-enhancement, and tone-scale remapping, for example.

Referring to FIGS. 3 and 4, the color-correction matrix coefficients for the color-correction matrix operation 40 are stored in a digital memory 36 colocated on the optical sub-assembly 20 with all of the other optical components. These coefficients are uniquely determined for each camera in order to correct the spectral sensitivities of the particular CCD imager 28 in the camera 10, and the spectral characteristics of the particular other elements in the optical sub-assembly 20, for the color sensitivities of the type of output device being used. (For this reason, while representing a specific imaging device, the coefficients are ordinarily calculated in relation to a reference output device, rather than a specific individual output device.) These coefficients are then applied to the color-correction matrix operation 40 for color-correction of the capture image. This approach has advantages in the production and service environments. In the production environment, optical sub-assemblies 20 can be fabricated, calibrated, and stocked for later integration into the final product without the need for calibrating the final product. In the service environment, since the optical sub-assembly 20 is replaceably interconnected to the preprocessing section 34 through the electrical connecting means 35, optical sub-assemblies 20 can be simply replaced without the need for calibrating the repaired product. Since each optical sub-assembly 20 is calibrated for the particular optical components on the sub-assembly, it may be appreciated that the matrix coefficients stored in the memory 36 are unique for each sub-assembly 20, and therefore for each camera 10.

Note that, although RGB signals have been discussed by way of example as the tristimulus format of choice for representing the scene color information, this invention is not restricted to use with this format alone. Other tristimulus formats such as the CIE XYZ format are equally applicable and may, in fact, present advantages in a particular implementation. Since the CIE XYZ format is a device independent space based on a set of CMFs defined by the CIE 1931 Standard Colorimetric Observer (2°), the matrix coefficients could be used to generate an input profile unique to each camera which will correct the spectral sensitivities of the camera for the standardized CMFs of this device independent space. For example, in one application following the ICC Profile Format Specification (Version 3.2, Nov. 20, 1995, published by the International Color Consortium), RGB input profiles are established which will correct the spectral sensitivities of an input device for a connection space. Thereupon, output profiles are used to convert the signals from the connection space to a format that is expected by an output device. It should therefore be understood that this invention encompasses linear tristimulus formats in general while the discussion is limited to the familiar RGB format for ease of understanding.

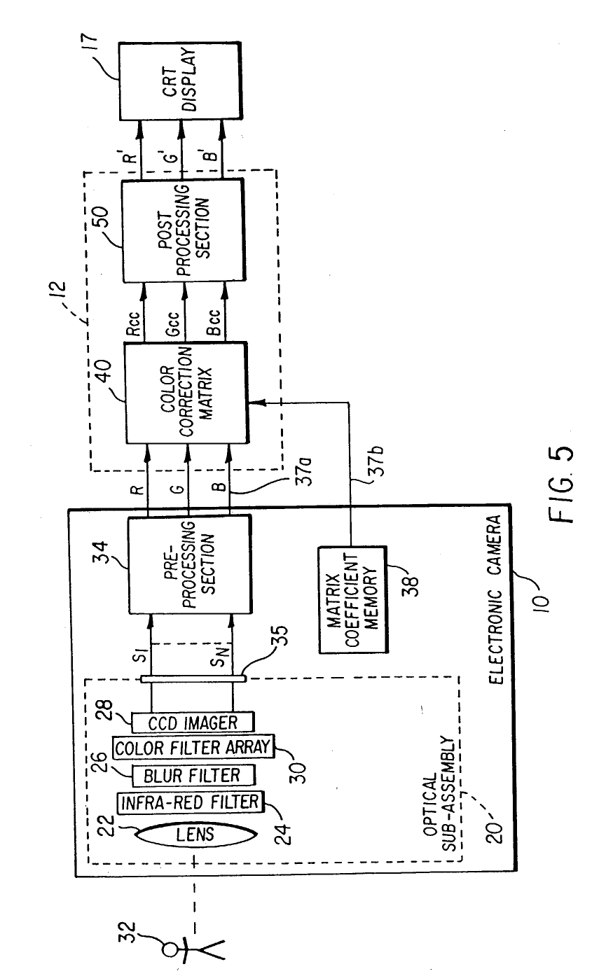

FIG. 5 illustrates the color-correction matrix coefficients for the color-correction matrix operation 40 are stored in a digital memory 38 located somewhere within the camera 10 but not necessarily on the optical sub-assembly 20. As disclosed in U.S. Pat. No. 5,668,596, aforementioned advantages in the production and service environments are not realizable but the color reproduction accuracy and consistency goals of the invention are not compromised.

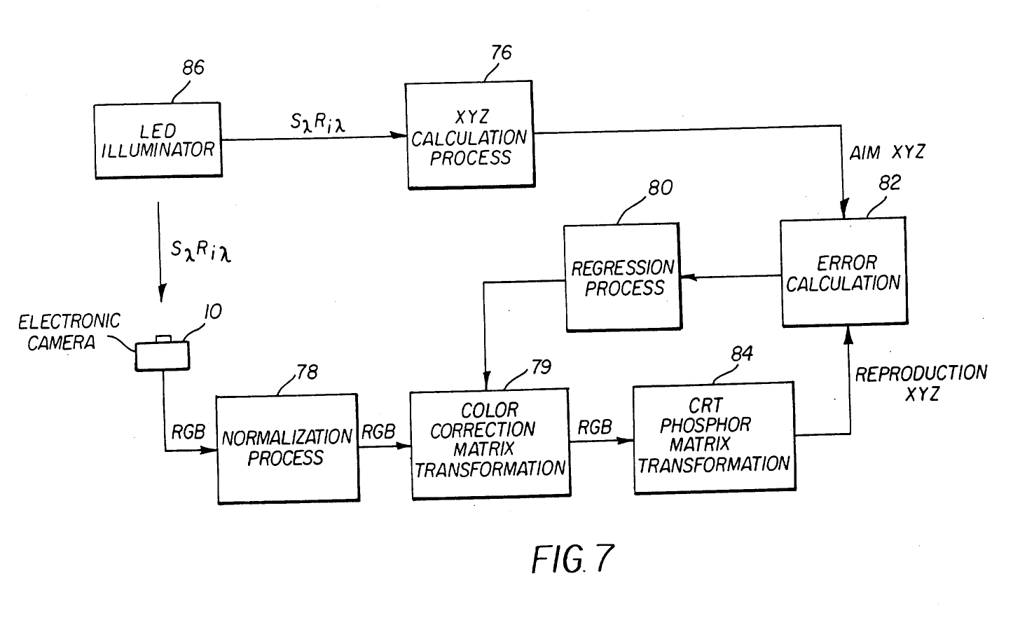

Various locations of the color-correction matrix coefficients within the camera as well as their application in the image processing path have been described in U.S. Pat. No. 5,668,596. According to FIG. 7, the general method of the invention for obtaining these coefficients is illustrated using an LED illuminator 86. Important to the present invention, an LED illuminator 86, described for instance in U.S. patent application Ser. No. 10/108,975, filed Mar. 28, 2002 by Richard M. Vogel, et al., and titled “Illuminator And Method Of Making Same,” having programmable output characteristics and spectral characteristics of the expected range of real world colors provides the basis for the coefficients calculation process.

Referring to FIG. 7, LED illuminator 86 replaces the color chart and illuminant described in U.S. Pat. No. 5,668,596. The LED illuminator 86 provides a spectral power distribution (SPD) at its output port corresponding to the SPD produced by each patch of the color chart described in the aforementioned patent under the illuminant. The SPD for each color patch and illuminant combination are generated sequentially by the LED illuminator and captured individually by the electronic camera. RGB camera values representative of the set of “color patch” images are subsequently determined. The color-correction matrix transformation 40 is then determined in the same way as described in U.S. Pat. No. 5,668,596. The electronic camera 10 may be calibrated in a system containing an LED illuminator 86 and executing a color-correction matrix calculation algorithm as discussed in U.S. Pat. No. 5,668,596. Such a system is described in U.S. application Ser. No. 10/109,221, filed Mar. 28, 2002, by Richard M. Vogel, et al., and titled “System and Method for Calibrating an Image Capture Device.”

Referring again to FIG. 7, a necessary first step of the method of calculating a set of color-correction matrix coefficients for an image capturing device includes providing an LED illuminator 86 (as described above) having programmable output characteristics and spectral characteristics.

The LED illuminator 86 is programmed to sequentially output spectral profiles for a pre-determined set of “color patches,” representative of the expected range of real world colors, to serve as the basis for the coefficients calculation process. Each of these spectral profiles also contains the effect of the desired illuminant. Spectral profiles of important colors such as foliage, blue sky, flesh tones, etc. may be included, as contained for example, in the well known Macbeth Color Checker™.

According to FIG. 7, a necessary second step 76 involves calculation of CIE tristimulus values (XYZ), describing the location of a particular “color patch” in the 3-dimensional XYZ color space, from the measured spectral data. This calculation procedure is described in the aforementioned CIE publication 15.2 (1986) Colorimetry—Second Edition on pages 22-23. This set of XYZ values becomes the calorimetric aims for the color-correction matrix coefficient calculation process. The electronic camera 10, described above, is then used to capture an image of each of the sequential “color patches” presented by the LED illuminator 86.

Referring still to FIG. 7, the average RGB signals for each of the sequentially captured images are computed. These average RGB camera signals from each image are then subjected to a normalization process 78 to provide a set of RGB signals that vary linearly with scene luminance. The normalization process 78 may include removal of the camera gamma/knee characteristic as well as black-level, white-balance, and exposure errors.

Linear RGB signals are transformed to a set of color-corrected RGB signals by color-correction matrix transformation 40. Initially this matrix is set equal to the identity matrix. The coefficients are subsequently adjusted in an iterative fashion by a regression process 80 until the average color error for all of the sequentially captured “color patches” is reduced to a predetermined level.

The set of color-corrected RGB signals from color-correction matrix transformation 79 are retransformed to a set of CIE XYZ signals by CRT phosphor matrix transformation 84. These signals represent the colors that would appear on the face of a reference CRT when presented with the color-corrected RGB signals from color-correction matrix transformation 79. It would be understood by someone skilled in the art that these color-corrected signals would first need to be modified to account for the nonlinear characteristic of the CRT phosphors. The resulting XYZ signals from CRT phosphor transformation matrix 84 represent the reproduced colors for each sequentially captured “color patch” for a reference output device, in this case the reference CRT.

Referring yet again to FIG. 7, an error calculation process 82 determines the average error between the aim and reproduction signals for all of the sequentially captured “color patches.” An individual color error is first computed for each “color patch” using the square-root of the sum of the squares of the differences of the aim and reproduction X, Y, and Z signals. This represents the vector length between the location of the aim and reproduction colors in the 3-dimensional XYZ color space. The last part of the error calculation is to average the individual color errors. This average color error is used in the regression process 80.

The foregoing matrix coefficient calculation process has been described from the standpoint of obtaining a good calorimetric match between the original scene and its reproduction on an additive type of display such as a CRT display. It will be understood by someone skilled in the art that this procedure is equally applicable to situations involving a LCD or OLED display. For some applications this may not be the desired color reproduction goal. Modifications to the method shown in FIG. 7 may be made to achieve a preferred color reproduction goal by taking into account such factors as chromatic adaptation and more perceptually uniform color spaces in which to perform the error minimization.

The invention has been described with reference to a preferred embodiment. However, it will be appreciated that variations and modifications can be effected by a person of ordinary skill in the art without departing from the scope of the invention.

### Parts List

10 electronic camera

11 electronic scanner

12 image processing external to camera (peripheral digital processor)

13 interface cable

14 digital interface

15 memory card, removable

16 card reader

17 color CRT display

18 printer, color

18a color print

19 keyboard

20 optical sub-assembly

22 lens

24 infra-red cutoff filter

26 blur filter

28 CCD Imager

30 color filter array (CFA)

32 scene

34 camera video pre-processing section

35 electrical connecting means

36 color-correction matrix coefficient memory on optical sub-assembly

37a interface line

37b interface line

38 color-correction matrix coefficient memory in camera

40 color-correction matrix transformation

50 post-processing section

76 XYZ calculation process

78 normalization process

79 color-correction matrix transformation

80 regression process

Parts List—continued

82 color error calculation process

84 CRT Phosphor Matrix Transformation

86 LED Illuminator

What is claimed is:

1. Method of calculating a set of color-correction matrix coefficients for an image capturing device, comprising the steps of:
(a) providing an LED illuminator having programmable output characteristics and spectral characteristics;
(b) programming said LED illuminator to sequentially output spectral profiles for a predetermined set of color patches representing a wide range of real world colors;
(c) providing a predetermined set of object stimulus containing at least some of said wide range of real world colors;
(d) computing tristimulus values for each one of said predetermined set of object stimulus, thereby creating a first XYZ data set defining the location of a particular color patch of said predetermined set of color patches;
(e) capturing an image of each one of said predetermined set of object stimulus thereby producing a plurality of images;
(f) determining an average RGB value based on each one of said plurality of images;
(g) normalizing said RGB values to eliminate effects of tone scale errors associated with each one of said plurality of images, thereby creating an RGB data set; and,
(h) calculating a set of color-correction matrix coefficients for said RGB data set corresponding to said first XYZ data set, thereby producing a color corrected RGB data set.

2. The method recited in claim 1 further comprising the step of converting the color corrected RGB data set to a second XYZ data set representative of an output display device.

3. The method recited in claim 2 further comprising comparing said first XYZ data set to said second XYZ data set.
